(19) United States
(12) Patent Application Publication
(10) Pub. No.: US 2025/0210829 A1
(43) Pub. Date: Jun. 26, 2025

(54) RECHARGEABLE BATTERY

(71) Applicant: SAMSUNG SDI CO., LTD., Yongin-Si Gyeonggi-do (KR)

(72) Inventors: Jihwan KIM, Yongin-Si (KR); Jun-Sun YONG, Yongin-Si (KR); Kwangsoo BAE, Yongin-Si (KR); Junhyung LEE, Yongin-Si (KR); Chaeeun BAE, Yongin-Si (KR); Heyoungcheoul ROH, Yongin-Si (KR); Jungwoo LEE, Yongin-Si (KR)

(21) Appl. No.: 18/651,232

(22) Filed: Apr. 30, 2024

(30) Foreign Application Priority Data
Dec. 21, 2023 (KR) 10-2023-0188484

(51) Int. Cl. H01M 50/552; H01M 50/184; H01M 50/186; H01M 50/531; H01M 50/562

(52) U.S. Cl. CPC H01M 50/552; H01M 50/184; H01M 50/186; H01M 50/531; H01M 50/562

(57) ABSTRACT

A rechargeable battery includes: an electrode assembly; a case to accommodate the electrode assembly; a subplate including: a first planar portion connected to the electrode assembly; and a protruding portion protruding on the first planar portion; a cap plate coupled to an open first side of the case; and a terminal plate on the cap plate, and electrically connected to the subplate, the terminal plate including: a recessed first portion including a bottom surface; and a second portion including a second planar portion connected to the recessed first portion. The recessed first portion of the terminal plate is in contact with the protruding portion of the subplate.

### CROSS REFERENCE TO RELATED APPLICATION

The present application claims priority to and the benefit of Korean Application No. 10-2023-0188484, filed on Dec. 21, 2023, in the Korean Intellectual Property Office, the entire disclosure of which is incorporated by reference herein.

### BACKGROUND

### 1. Field

Aspects of embodiments of the present disclosure relate to a rechargeable battery.

### 2. Description of the Related Art

A secondary battery refers to a rechargeable battery that may be charged and discharged multiple times. Such rechargeable batteries may be mainly used in various applications, such as electronics (e.g., smartphones, laptops, and tablets), electric vehicles, solar power generation, and emergency power supplies. In particular, lithium (Li)-ion batteries have high energy density and high charge and discharge efficiency, and thus, are used in various electronic products and electric vehicles.

Rechargeable batteries may be categorized as cylindrical rechargeable batteries, prismatic rechargeable batteries, and pouch rechargeable batteries, depending on the shape of the case thereof. A prismatic rechargeable battery has a structure in which an electrode assembly is embedded in a cylindrical metal can. The electrode assembly is inserted into the prismatic metal can, and the can is sealed by welding a cap plate thereto. In this case, manufacturing costs and the process difficulty may increase depending on the structure of the integrated body connected to the electrode assembly.

The above information disclosed in this Background section is for enhancement of understanding of the background of the present disclosure, and therefore, it may contain information that does not constitute prior art.

### SUMMARY

One or more embodiments of the present disclosure may be directed to a rechargeable battery having reduced manufacturing costs and/or improved reliability.

The above and other aspects and features of the present disclosure will be described in, or will be more apparent from, the following description of some embodiments of the present disclosure.

According to one or more embodiments of the present disclosure, a rechargeable battery includes: an electrode assembly; a case configured to accommodate the electrode assembly; a subplate including: a first planar portion connected to the electrode assembly; and a protruding portion protruding on the first planar portion; a cap plate coupled to an open first side of the case; and a terminal plate on the cap plate, and electrically connected to the subplate, the terminal plate including: a recessed first portion including a bottom surface; and a second portion including a second planar portion connected to the recessed first portion. The recessed first portion of the terminal plate is in contact with the protruding portion of the subplate.

In an embodiment, a thickness of the recessed first portion may be greater than a thickness of the protruding portion.

In an embodiment, the first planar portion and the protruding portion of the subplate may have the same thickness as each other.

In an embodiment, the recessed first portion that is in contact with the protruding portion may protrude from a bottom surface of the second portion toward the protruding portion.

In an embodiment, the rechargeable battery may further include a sealing member coupled onto the cap plate, and the sealing member may be located between the second portion of the terminal plate and the subplate.

In an embodiment, the sealing member may have a through-hole, and the recessed first portion of the terminal plate may be located in the through-hole.

In an embodiment, the recessed first portion of the terminal plate and the protruding portion of the subplate may be in contact with each other in the through-hole of the sealing member.

In an embodiment, the protruding portion of the subplate may have a cylindrical shape, and an interior of the protruding portion may be hollow.

In an embodiment, an upper surface of the recessed first portion of the terminal plate may be lower than an upper surface of the second portion of the terminal plate.

In an embodiment, the recessed first portion of the terminal plate may expose a portion of the protruding portion.

In an embodiment, the subplate may include a forged product.

In an embodiment, the terminal plate may further include a welding area on an upper surface of the recessed first portion.

In an embodiment, the case may include: a first long sidewall portion and a second long sidewall portion opposite to and spaced from each other; and a first short sidewall portion and a second short sidewall portion opposite to and spaced from each other. Areas of the first short sidewall portion and the second short sidewall portion may be smaller than areas of the first long sidewall portion and the second long sidewall portion, respectively.

According to one or more embodiments of the present disclosure, a rechargeable battery includes: an electrode assembly; a case configured to accommodate the electrode assembly; a subplate including: a first planar portion connected to the electrode assembly; and a first protruding portion protruding on the 1 first planar portion; a cap plate coupled to an open first side of the case; and a terminal plate on the cap plate, and electrically connected to the subplate, the terminal plate including: a first portion including a second protruding portion protruding toward the first protruding portion; and a second portion including a second planar portion in contact with the first portion. The first portion of the terminal plate is in contact with the first protruding portion of the subplate.

In an embodiment, the first planar portion and the first protruding portion of the subplate may have a same thickness as each other.

In an embodiment, the first portion and the second portion may include

different materials from each other.

In an embodiment, the first portion may include copper, and the second portion may include aluminum.

In an embodiment, the first portion may include a third planar portion in contact with the second portion.

In an embodiment, the second portion may have a hole exposing the first portion.

According to one or more embodiments of the present disclosure, a rechargeable battery includes: an electrode assembly; a case configured to accommodate the electrode assembly, and having an open first side and an open second side opposite to each other; a first subplate including: a first planar portion connected to a first side of the electrode assembly; and a first protruding portion protruding on the first planar portion; a first cap plate coupled to the open first side of the case; a first terminal plate on the first cap plate, and electrically connected to the first subplate, the first terminal plate including: a recessed first portion including a bottom surface; and a second portion including a third planar portion connected to the recessed first portion; a second subplate including: a second planar portion connected to a second side of the electrode assembly; and a second protruding portion protruding on the second planar portion; a second cap plate coupled to the open second side of 1 the case; and a second terminal plate on the second cap plate, and electrically connected to the second subplate, the second terminal plate including: a third portion including a third protruding portion protruding toward the second protruding portion; and a fourth portion including a fourth planar portion in contact with the third portion. The recessed first portion of the first terminal plate is in contact with the first protruding portion of the first subplate, and the third portion of the second terminal plate is in contact with the second protruding portion of the second subplate.

According to one or more embodiments of the present disclosure, each of the first subplate and the second subplate may be implemented as a forged product to reduce the difficulty of a manufacturing process and defects in a rechargeable battery, thereby improving the reliability of the rechargeable battery.

According to one or more embodiments of the present disclosure, each of the first subplate and the second subplate may be implemented as a forged product to reduce manufacturing costs of the rechargeable battery.

According to one or more embodiments of the present disclosure, whether or not the terminal plate and the subplate are tightly fitted may be determined using a hole in the terminal plate. Accordingly, defects in the process of manufacturing a rechargeable battery may be reduced, and the reliability of the rechargeable battery may be improved.

In embodiments of the present disclosure, the current collector may be removed to reduce material costs.

However, the aspects and features of the present disclosure are not limited to those described above, and the above and other aspects and features will be more clearly understood to those having ordinary skill in the art from the detailed description with reference to the drawings, and in part, may be apparent therefrom, or may be learned by practicing one or more of the presented embodiments of the present disclosure.

### BRIEF DESCRIPTION OF THE DRAWINGS

The above and other aspects and features of the present disclosure will be more clearly understood from the following detailed description of the illustrative, non-limiting embodiments with reference to the accompanying drawings, in which:

FIG. 1 illustrates a perspective view showing a rechargeable battery according to some embodiments of the present disclosure;

FIG. 2 illustrates a cross-sectional view showing a rechargeable battery according to some embodiments of the present disclosure;

FIG. 3 illustrates a perspective view illustrating a case according to some embodiments of the present disclosure;

FIG. 4 illustrates an enlarged view of the region R1 in FIG. 2;

FIG. 5 illustrates a first cap assembly and a first subplate assembly according to some embodiments of the present disclosure;

FIG. 6 illustrates a first welding area formed on a first terminal plate according to some embodiments of the present disclosure;

FIG. 7 illustrates an enlarged view of the region R2 in FIG. 2;

FIG. 8 illustrates a view showing a second cap assembly and a second subplate assembly according to some embodiments of the present disclosure;

FIG. 9 illustrates a second welding area formed on a second terminal plate according to some embodiments of the present disclosure;

FIGS. 10 and 11 illustrate a rechargeable battery according to some embodiments of the present disclosure;

FIG. 12 illustrates a rechargeable battery according to some embodiments of the present disclosure.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

When a certain embodiment may be implemented differently, a specific process order may be different from the described order. For example, two consecutively described processes may be performed at the same or substantially at the same time, or may be performed in an order opposite to the described order.

In the drawings, the relative sizes, thicknesses, and ratios of elements, layers, and regions may be exaggerated and/or simplified for clarity. Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

In the figures, the x-axis, the y-axis, and the z-axis are not limited to three axes of the rectangular coordinate system, and may be interpreted in a broader sense. For example, the x-axis, the y-axis, and the z-axis may be perpendicular to or substantially perpendicular to one another, or may represent different directions from each other that are not perpendicular to one another.

Any numerical range disclosed and/or recited herein is intended to include all sub ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited herein is intended to include all higher numerical limitations subsumed therein.

References to two compared elements, features, and the like as being “the same” may mean that they are “substantially the same”. Thus, the phrase “substantially the same” may include a case having a deviation that is considered low in the art, for example, such as a deviation of 5% or less. In addition, when a certain parameter is referred to as being uniform in a given region, it may mean that it is uniform in terms of an average.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “on,” “connected to,” or “coupled to” another element or layer, it can be directly on, connected to, or coupled to the other element or layer, or one or more intervening elements or layers may be present. Similarly, when a layer, an area, or an element is referred to as being “electrically connected” to another layer, area, or element, it may be directly electrically connected to the other layer, area, or element, and/or may be indirectly electrically connected with one or more intervening layers, areas, or elements therebetween. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments and is not intended to be limiting of the present disclosure. As used herein, the singular forms “a” and “an” are intended to include the plural forms as well, unless the context clearly indicates otherwise. It will be further understood that the terms “comprises,” “comprising,” “includes,” “including,” “has,” “have,” and “having,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, the expression “A and/or B” denotes A, B, or A and B. Expressions such as “at least one of,” when preceding a list of elements, modify the entire list of elements and do not modify the individual elements of the list. For example, the expression “at least one of a, b, or c,” “at least one of a, b, and c,” and “at least one selected from the group consisting of a, b, and c” indicates only a, only b, only c, both a and b, both a and c, both b and c, all of a, b, and c, or variations thereof.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present disclosure refers to “one or more embodiments of the present disclosure.” As used herein, the terms “use,” “using,” and “used” may be considered synonymous with the terms “utilize,” “utilizing,” and “utilized,” respectively.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

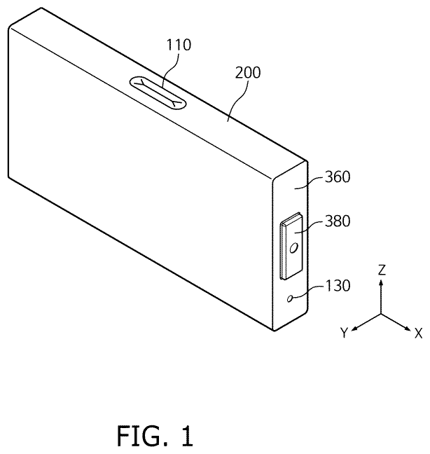

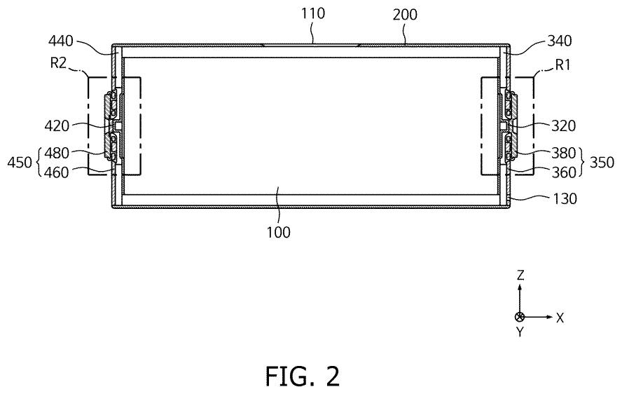

FIG. 1 illustrates a perspective view showing a rechargeable battery according to some embodiments of the present disclosure. FIG. 2 illustrates a cross-sectional view showing a rechargeable battery according to some embodiments of the present disclosure.

Referring to FIGS. 1 and 2, the rechargeable battery may include an electrode assembly 100, a case 200 containing the electrode assembly 100, a first subplate 320, a second subplate 420, a first cap assembly 350, and a second cap assembly 450.

The electrode assembly 100 may be contained in the case 200. The electrode assembly 100 may be formed by winding or stacking a laminate of a first electrode plate, a separator, and a second electrode plate, each formed as a thin plate or film. In a case where the electrode assembly 100 is a wound laminate, the axis of the winding thereof may be parallel to or substantially parallel to the longitudinal direction of the case 200. In addition, the electrode assembly 100 may be a stack type instead of being a wound type, but the present disclosure is not limited thereto. In addition, the electrode assembly 100 may be a Z stack electrode assembly in which a positive electrode plate and a negative electrode plate are provided on opposite sides of a separator bent as a Z stack. In addition, one or more electrode assemblies 100 may be stacked, so that the long sides thereof are adjacent to each other, and received in the case 200. The present disclosure is not limited to any particular number of electrode assemblies 100. In the electrode assembly 100, the first electrode plate may act as a positive electrode, and the second electrode plate may act as a negative electrode. However, the reverse may also be possible.

The first electrode plate may be formed by applying a first electrode active material, such as graphite or carbon, to a first electrode collector plate formed of a metal foil of, for example, copper (Cu), a Cu alloy, nickel (Ni), or a Ni alloy. The first electrode plate may include a first electrode tab (e.g., a first uncoated portion), which is a region to which the first electrode active material is not applied. The first electrode tab may be a path for a current flow between the first electrode plate and the first subplate 320. In some embodiments, the first electrode tab may be formed by cutting (e.g., previously cutting) the first electrode plate so that the first electrode tab protrudes from a first side when the first electrode plate is fabricated, and may protrude further from the first side than the separator without additional cutting.

The second electrode plate may be formed by applying a second electrode active material, such as a transition metal oxide, to a second electrode collector plate formed of a metal foil of, for example, Al or an Al alloy. The second electrode plate may include a second electrode tab (e.g., a second uncoated portion), which is a region to which the second electrode active material is not applied. The second electrode tab may be a path for a current flow between the second electrode plate and the second subplate 420. In some embodiments, the second electrode tab may be formed by cutting (e.g., previously cutting) the second electrode plate so that the second electrode tab protrudes from a second side when the second electrode plate is fabricated, and may protrude further from the second side than the separator without additional cutting.

In some examples, the first electrode tab may be positioned on the right end side of the electrode assembly, and the second electrode tab may be positioned on the left end side of the electrode assembly. The terms “left” and “right” are used herein for convenience of illustration with reference to the rechargeable battery illustrated in FIG. 2, and the positions may be variously modified as the rechargeable battery is rotated left and right and/or up and down.

In some embodiments, an electrolyte inlet 130 may be provided in a first cap plate 360. An electrolyte may be injected into the case 200 through the electrolyte inlet 130. In FIG. 1, the electrolyte inlet 130 is illustrated as being provided on the first cap plate 360, but the present disclosure is not limited thereto. After the electrolyte injection is complete, the electrolyte inlet 130 may be sealed using a sealing means such as a stopper.

In some embodiments, a vent 110 may be provided in a first side of the case 200. For example, the vent 110 may be provided in a bottom surface of the case 200. Herein, the bottom surface may refer to a surface facing downward in a case where the rechargeable battery is finally installed. The vent 110 may prevent or substantially prevent the rechargeable battery from exploding, or may prevent or substantially prevent a chain reaction of rechargeable batteries arranged in close proximity to one another.

As an example, the vent 110 may be configured to open in the event that the internal pressure of the rechargeable battery exceeds a critical pressure (e.g., a predetermined critical pressure). In this case, the critical pressure may be set differently depending on the application, material, purpose, and the like of the rechargeable battery. As another example, the vent 110 may be configured to be opened in the event that the internal temperature exceeds a critical temperature (e.g., a predetermined critical temperature).

In FIG. 1, the vent 110 is illustrated as being a single vent provided at the center of one surface of the case 200, but the present disclosure is not limited thereto. In other embodiments, any suitable number of vents 110 may be provided at any suitable positions in one surface of the case 200. For example, two or more vents 110 may be provided at (e.g., in or on) one surface of the case 200.

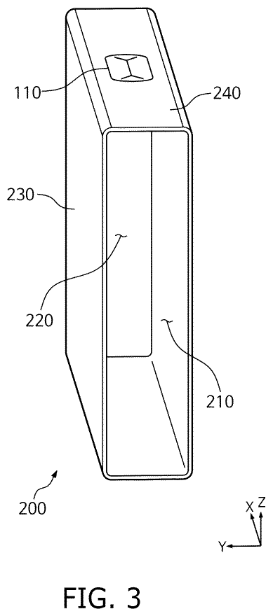

FIG. 3 illustrates a perspective view illustrating a case according to some embodiments of the present disclosure.

Referring to FIGS. 2 and 3, the case 200 may include long sidewalls 230 opposite to each other, short sidewalls 240 opposite to each other, an open first side 210, and an open second side 220.

A first direction X may refer to the X-axis direction. A second direction Y may be orthogonal to the first direction X. The second direction Y may refer to the Y-axis direction. A third direction Z may be orthogonal to the first direction X and the second direction Y. The third direction Z may refer to the Z-axis direction.

The long sidewalls 230 may include a first long sidewall portion and a second long sidewall portion. The first long sidewall portion and the second long sidewall portion may be opposite to each other. The first long sidewall portion and the second long sidewall portion may be opposite to each other, while being spaced apart from each other in the second direction Y.

The short sidewalls 240 may include a first short sidewall portion and a second short sidewall portion. The first short sidewall portion and the second short sidewall portion may be opposite to each other. The first short sidewall portion and the second short sidewall portion may be opposite to each other, while being spaced apart from each other in the third direction Z. The area of each of the first short sidewall portion and the second short sidewall portion may be smaller than the area of each of the first long sidewall portion and the second long sidewall portion.

The open first side 210 and the open second side 220 may be formed on opposite sides of the case 200, respectively. The open second side 220 may be opposite to the open first side 210. The open second side 220 and the open first side 210 may be opposite to each other while being spaced apart from each other in the first direction X. Each of the open first side 210 and the open second side 220 may refer to an open area.

The case 200 may be formed of a conductive metal, such as Al, an Al alloy, or Ni-plated steel.

The first cap plate 360 may cover the open first side 210, and be connected to (e.g., coupled to or attached to) the case 200. The second cap plate 460 may cover the open second side 220, and be connected to (e.g., coupled to or attached to) the case 200. For example, each of the first cap plate 360 and the second cap plate 460 may be welded to the case 200. The first cap plate 360 and the second cap plate 460 may seal the case 200.

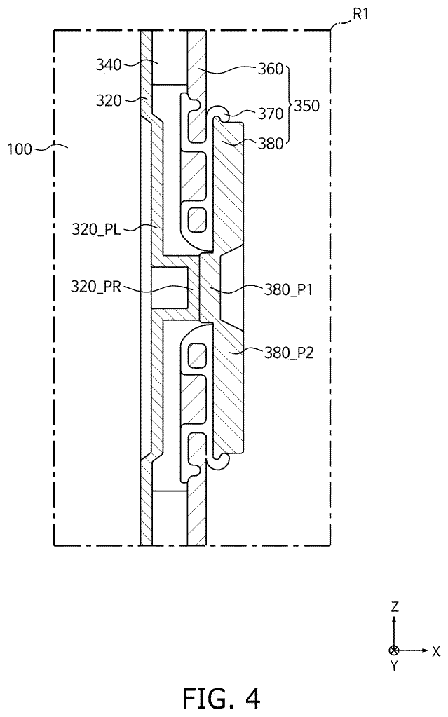

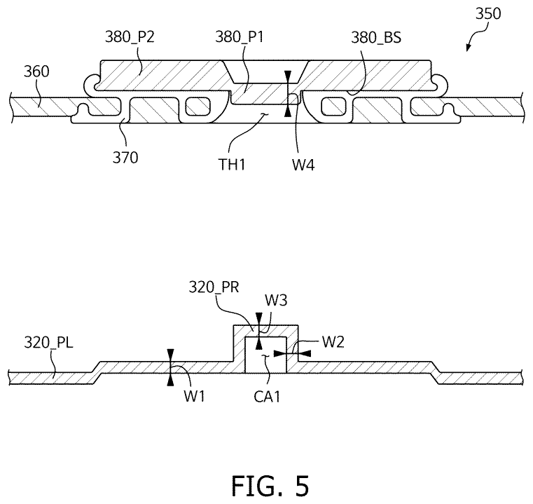

FIG. 4 illustrates an enlarged view of the region R1 in FIG. 2. FIG. 5 illustrates the first cap assembly and the first subplate assembly according to some embodiments of the present disclosure. For convenience, FIG. 5 illustrates a view in which the first cap assembly and the first subplate shown in FIG. 4 are separated from each other.

Referring to FIG. 4, the first subplate 320 and the first cap assembly 350 may be connected to (e.g., coupled to or attached to) the first side of the electrode assembly 100.

The first subplate 320 may be connected to (e.g., coupled to or attached to) the first side of the electrode assembly 100, and may be electrically connected to the first electrode plate (e.g., the positive electrode plate) of the electrode assembly 100. For example, the first electrode tab may be welded to the first subplate 320. The first subplate 320 may be connected to the first electrode tab.

A first insulation member 340 may be disposed between the first subplate 320 and the first cap assembly 350. The first insulation member 340 may prevent the first subplate 320 and the first cap plate 360 from contacting each other.

Referring to FIGS. 4 and 5, the first subplate 320 may include a first planar portion 320_PL and a first protruding portion 320_PR.

The first planar portion 320_PL may be connected to (e.g., coupled to or attached to) the first electrode tab by welding. The first protruding portion 320_PR may be a protrusion on the first planar portion 320_PL. The first protruding portion 320_PR may have a cylindrical shape. A cavity CA1 may be provided inside the first protruding portion 320_PR.

The first planar portion 320_PL may have a first thickness W1. A side surface of the first protruding portion 320_PR may have a second thickness W2, and the top surface of the first protruding portion 320_PR may have a third thickness W3.

In some embodiments, first subplate 320 may be implemented as a forged product. Thus, each of the first thickness W1, the second thickness W2, and the third thickness W3 may be the same or substantially the same as each other (e.g., the thickness of the first subplate 320 may be constant or substantially constant). However, the present disclosure is not limited thereto.

In some embodiments, the first thickness W1 and the third thickness W3 may be the same or substantially the same as each other. The second thickness W2 may be less than each of the first thickness W1 and the third thickness W3.

The first cap assembly 350 may include a first cap plate 360, a first sealing member 370, and a first terminal plate 380.

The first sealing member 370 may be connected to (e.g., coupled to or attached to) the first cap plate 360. The first sealing member 370 may include a first through-hole TH1. The first sealing member 370 may seal between the first terminal plate 380 and the first cap plate 360. The first sealing member 370 may include an insulating material. The first sealing member 370 may insulate the first cap plate 360 and the first terminal plate 380 from each other.

The first terminal plate 380 may be connected onto (e.g., coupled onto or attached onto) the first sealing member 370. The first terminal plate 380 may be the positive electrode terminal of a rechargeable battery. For example, a busbar may be welded to the first terminal plate 380 to be electrically connected to another rechargeable battery.

The first terminal plate 380 may include a first portion 380_P1 and a second portion 380_P2. The first portion 380_P1 and the second portion 380_P2 may be integrated with each other. The first portion 380_P1 may include a recessed bottom surface. The first portion 380_P1 may be in contact with the first protruding portion 320_PR. For example, the top surface of the first protruding portion 320_PR and the bottom surface of the first portion 380_P1 may be in contact with each other. The first portion 380_P1 may protrude from the bottom surface 380_BS of the first terminal plate 380 toward the first protruding portion 320_PR.

The first portion 380_P1 may have a fourth thickness W4. In this case, the fourth thickness W4 may be a distance (e.g., a minimum distance) from the top surface to the bottom surface of the first portion 380_P1. The fourth thickness W4 may be greater than the first thickness W1 of the first subplate 320.

The second portion 380_P2 may be disposed around (e.g., adjacent to) the first portion 380_P1. The second portion 380_P2 may include a planar portion continuous with the first portion 380_P1. The planar portion of the second portion 380_P2 may be disposed on the first sealing member 370. The bottom surface of the second portion 380_P2 may be the bottom surface 380_BS of the first terminal plate 380. With respect to the bottom surface 380_BS of the first terminal plate 380, the top surface of the first portion 380_P1 may be disposed lower than the top surface of the second portion 380_P2. The top surface of the first terminal plate 380 may include a recessed portion. The recessed portion may be defined as the top surface of the first portion 380_P1 and a side surface of the second portion 380_P2.

A portion of the first portion 380_P1 may be disposed in the first through-hole TH1. A portion of the first protruding portion 320_PR may be disposed in the first through-hole TH1. The first portion 380_P1 and the first protruding portion 320_PR may be in contact with each other in the first through-hole TH1. For example, the bottom surface of the first portion 380_P1 and the top surface of the first protruding portion 320_PR may be disposed in the first through-hole TH1.

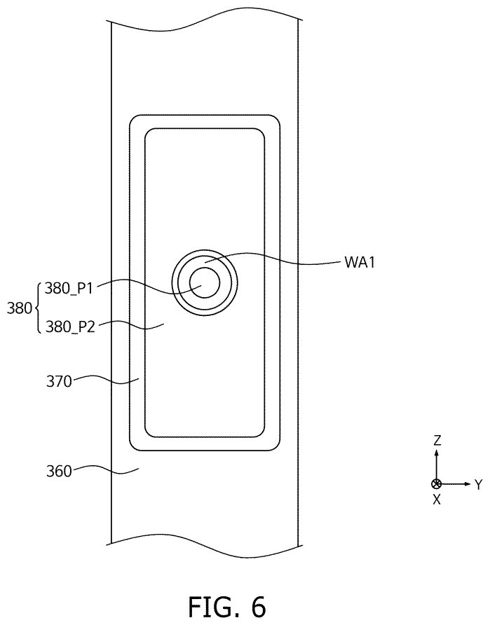

FIG. 6 illustrates a first welding area formed on the first terminal plate according to some embodiments of the present disclosure. For convenience, FIG. 6 may illustrate a plan view of the region R1 in FIG. 4 in the first direction X.

Referring to FIGS. 4 and 6, the first terminal plate 380 may further include a first welding area WA1 formed on the top surface of first portion 380_P1. A welding process may be performed on the first welding area WA1 to join the first terminal plate 380 and the first subplate 320 to each other. In more detail, the welding process may join the first portion 380_P1 and the first protruding portion 320_PR to each other by welding. As a result, the first subplate 320 and the first terminal plate 380 may be electrically connected to each other. A welding bead or the like may be formed on the first welding area WA1 due to the welding process. The first welding area WA1 is illustrated as having a donut shape, but the present disclosure is not limited thereto. The first welding area WA1 may have any suitable shape in which the first terminal plate 380 and the first subplate 320 are welded together.

A rechargeable battery may be manufactured by combining an electrode assembly with a collector, and the collector with a terminal plate. In such a rechargeable battery manufacturing process, a complex structure of the integrated circuit may increase the difficulty of the manufacturing process and may increase manufacturing costs. An increase in the difficulty of the manufacturing process may increase defects in the rechargeable battery, and may decrease the reliability of the rechargeable battery.

According to some embodiments of the present disclosure, the first subplate 320 may be connected to (e.g., coupled to or attached to) the first side of the electrode assembly 100, and the first subplate 320 and the first terminal plate 380 may be connected to (e.g., coupled to or attached to) each other. The first subplate 320 may be implemented as a forged product to reduce manufacturing costs. In addition, the first subplate 320 and the first terminal plate 380 may be connected to each other by a single welding process, thereby reducing the difficulty of the manufacturing process. Accordingly, defects in the rechargeable battery may be reduced, and the reliability of the rechargeable battery may be improved.

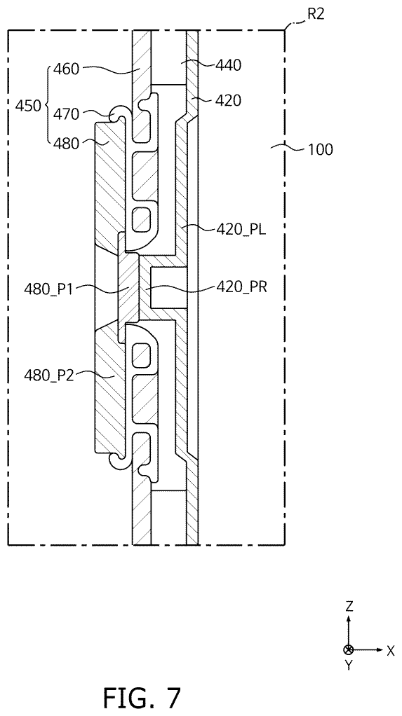

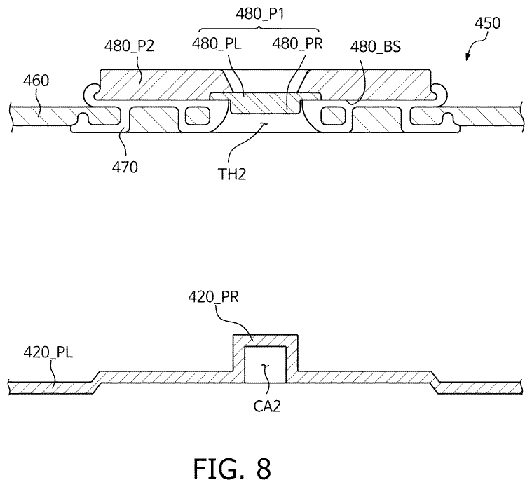

FIG. 7 illustrates an enlarged view of the region R2 in FIG. 2. FIG. 8 illustrates a view showing the second cap assembly and the second subplate assembly according to some embodiments of the present disclosure. For convenience, FIG. 8 illustrates a view in which the second cap assembly and the second subplate in FIG. 7 are separated from each other.

Referring to FIG. 7, the second subplate 420 and the second cap assembly 450 may be disposed on the first side of the electrode assembly 100.

The second subplate 420 may be connected to (e.g., coupled to or attached to) the first side of the electrode assembly 100, and electrically connected to a second electrode plate (e.g., a negative electrode plate) of the electrode assembly 100. For example, the second electrode tab may be connected to (e.g., coupled to or attached to) the second subplate 420 by welding. The second subplate 420 may be connected to the second electrode tab.

A second insulating member 440 may be disposed between the second subplate 420 and the second cap assembly 450. The second insulating member 440 may prevent the second subplate 420 and the second cap plate 460 from contacting each other.

Referring to FIGS. 7 and 8, the second subplate 420 may include a second planar portion 420_PL and a second protruding portion 420_PR.

The second planar portion 420_PL may be connected to (e.g., coupled to or attached to) the second electrode tab by welding. The second protruding portion 420_PR may be a protrusion on the second planar portion 430_PL. The second protruding portion 420_PR may have a cylindrical shape. A cavity CA2 may be provided inside the second protruding portion 420_PR.

The thickness of each of the second planar portion 420_PL and the second protruding portion 420_PR may be the same or substantially the same as that described above for the thickness of each of the first planar portion 320_PL and the first protruding portion 320_PR with reference to FIG. 5. For example, in some embodiments, the second subplate 420 may be implemented as a forged product. Thus, the thickness of the second subplate 420 may be constant or substantially constant.

The second cap assembly 450 may include the second cap plate 460, a second sealing member 470, and a second terminal plate 480.

The second sealing member 470 may be connected to (e.g., coupled to or attached to) the second cap plate 460. The second sealing member 470 may include a second through-hole TH2. The second sealing member 470 may seal between the second terminal plate 480 and the second cap plate 460. The second sealing member 470 may include an insulating material. The second sealing member 470 may insulate the second cap plate 460 and the second terminal plate 480 from each other.

The second terminal plate 480 may be connected onto (e.g., coupled onto or attached onto) the second sealing member 470. The second terminal plate 480 may be the negative electrode terminal of the rechargeable battery. For example, a busbar may be welded to the second terminal plate 480 to be electrically connected to another rechargeable battery.

The second terminal plate 480 may include a third portion 480_P1 and a fourth portion 480_P2. The third portion 480_P1 may be in contact with the second protruding portion 420_PR. For example, the top surface of the second protruding portion 420_PR and the bottom surface of the third portion 480_P1 may be in contact with each other. The third portion 480_P1 may protrude from a bottom surface 480_BS of the second terminal plate 480 toward the second protruding portion 420_PR. The thickness of the third portion 480_P1 may be greater than the thickness of the second subplate 420.

The third portion 480_P1 may include a third planar portion 480_PL and a third protruding portion 480_PR. The third protruding portion 480_PR may protrude toward the second protruding portion 420_PR on the third planar portion 480_PL. The third planar portion 480_PL may be in contact with the fourth portion 480_P2.

The fourth portion 480_P2 may be disposed around (e.g., adjacent to) the third portion 480_P1. The fourth portion 480_P2 may include a planar portion in contact with the third portion 480_P1. The planar portion of the fourth portion 480_P2 may be disposed on the second sealing member 470. The fourth portion 480_P2 may expose a portion of the third portion 480_P1. For example, a portion of the third portion 480_P1 may be exposed through a hollow in the central portion of the fourth portion 480_P2. The bottom surface of the fourth portion 480_P2 may be the bottom surface 480_BS of the second terminal plate 480. With respect to the bottom surface 480_BS of the second terminal plate 480, the top surface of the third portion 480_P1 may be disposed lower than the top surface of the fourth portion 480_P2. The top surface of the second terminal plate 480 may include a recessed portion. The recessed portion may be defined as the top surface of the third portion 480_P1 and a side of the fourth portion 480_P2.

In some embodiments, the third portion 480_P1 and the fourth portion 480_P2 may be formed of different materials from each other. The third portion 480_P1 may include, for example, Cu. The fourth portion 480_P2 may include, for example, Al. In more detail, the third portion 480_P1 may be a conductive material having a major constituent of Cu. The fourth portion 480_P2 may be a conductive material having a major constituent of Al. As used herein, the phrase “major constituent” refers to a substance having the predominant content from among the substances of an alloy, from the standpoint of a person having ordinary skill in the art.

Although the third portion 480_P1 has been described as including Cu and the fourth portion 480_P2 has been described as including Al, the present disclosure is not limited thereto. In some embodiments, the third portion 480_P1 and the fourth portion 480_P2 may include different conductive metals from each other.

The third planar portion 480_PL may be disposed in the second through-hole TH2. A portion of the second protruding portion 420_PR may be disposed in the second through-hole TH2. The third portion 480_P1 and the second protruding portion 420_PR may be in contact with each other in the second through-hole TH2. For example, the bottom surface of the third portion 480_P1 and the top surface of the second protruding portion 420_PR may be disposed in the second through-hole TH2.

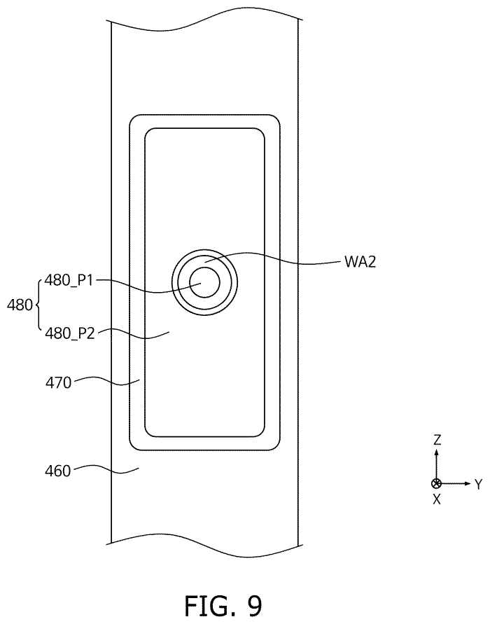

FIG. 9 illustrates a second welding area formed on the second terminal plate according to some embodiments of the present disclosure. For convenience, FIG. 9 may be a plan view of the region R2 in FIG. 4 in the first direction X.

Referring to FIGS. 7 and 9, the second terminal plate 480 may further include a second welding area WA2 formed on the top surface of the third portion 480_P1. A welding process may be performed on the second welding area WA2 to join the second terminal plate 480 and the second subplate 420 to each other. In more detail, the third portion 480_P1 and the second protruding portion 420_PR may be welded together by the welding process. As a result, the second subplate 420 and the second terminal plate 480 may be electrically connected to each other. A welding bead or the like may be formed on the second welding area WA2 due to the welding process. The second welding area WA2 is illustrated as having a donut shape, but the present disclosure is not limited thereto. The second welding area WA2 may have any suitable shape in which the second terminal plate 480 and the second subplate 420 are welded together.

According to some embodiments of the present disclosure, the second subplate 420 may be connected to (e.g., coupled to or attached to) the first side of the electrode assembly 100, and the second subplate 420 and the second terminal plate 480 may be connected to (e.g., coupled to or attached to) each other. The second subplate 420 may be implemented as a forged product, thereby reducing manufacturing costs. Furthermore, the second subplate 420 and the second terminal plate 480 may be connected to each other by a single welding process, thereby reducing the difficulty of the manufacturing process. Accordingly, defects in the rechargeable battery may be reduced, and the reliability of the rechargeable battery may be improved.

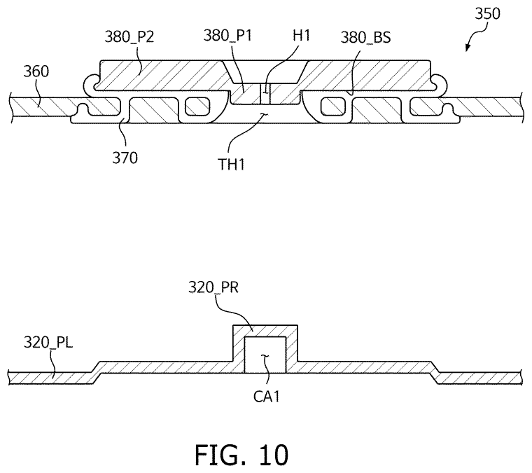

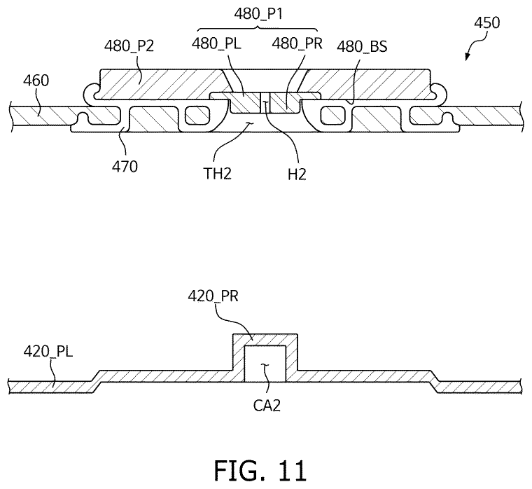

FIGS. 10 and 11 illustrate the rechargeable battery according to some embodiments of the present disclosure. FIG. 10 is an enlarged view illustrating the first cap assembly and the first subplate according to some embodiments of the present disclosure. FIG. 11 illustrates an enlarged view showing the second cap assembly and the second subplate according to some embodiments of the present disclosure. For convenience, features different from those described above with reference to FIGS. 5 and 8 may be described in more detail hereinafter.

Referring to FIG. 10, the first terminal plate 380 may include a first hole H1. The first hole H1 may expose a portion of the first subplate 320. In more detail, the first hole H1 may be formed in the first portion 380_P1. The first hole H1 may extend through (e.g., may penetrate) the first portion 380_P1. In a case where the first subplate 320 and the first cap assembly 350 are connected to (e.g., coupled to or attached to) each other, the first hole H1 may expose a portion of the top surface of the first protruding portion 320_PR.

The first subplate 320 and the first terminal plate 380 may be welded to each other. For example, a welding area may be formed on the top surface of the first portion 380_P1. The welding area may be formed around the first hole H1. A welding process may be performed on the welding area to join the first terminal plate 380 and the first subplate 320 to each other. Accordingly, the first subplate 320 and the first terminal plate 380 may be electrically connected to each other. A welding bead or the like may be formed on the welding area due to the welding process.

Referring to FIG. 11, the second terminal plate 480 may include a second hole H2. The second hole H2 may expose a portion of the second subplate 420. In more detail, the second hole H2 may be formed in the third portion 480_P1. The second hole H2 may extend through (e.g., may penetrate) the third portion 480_P1. The second hole H2 may extend through each of the third planar portion 480_PL and the third protruding portion 480_PR. In a case where the second subplate 420 and the second cap assembly 450 are combined with each other, the second hole H2 may expose a portion of the top surface of the second protruding portion 420_PR.

The second subplate 420 and the second terminal plate 480 may be welded to each other. For example, a welding area may be formed on the top surface of the third portion 480_P1. The welding area may be formed around the second hole H2. A welding process may be performed in the welding area to join the second terminal plate 480 and the second subplate 420 to each other. Accordingly, the second subplate 420 and the second terminal plate 480 may be electrically connected to each other. A welding bead or the like may be formed on the welding area by the welding process.

In a rechargeable battery manufacturing process, in a case where the cap plate and the subplate are not tightly fitted, a defect in the welding process may occur. According to some embodiments of the present disclosure, the first terminal plate 380 may include the first hole H1, and the second terminal plate 480 may include the second hole H2. Whether or not the first and second subplates 320 and 420 are tightly fitted and whether or not the first and second terminal plates 380 and 480 are tightly fitted may be determined by the first and second holes H1 and H2, respectively. Accordingly, defects may be reduced in the process of manufacturing a rechargeable battery.

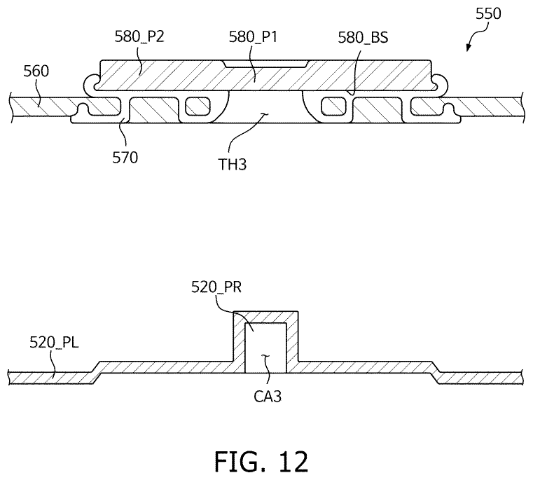

FIG. 12 illustrate the rechargeable battery according to some embodiments of the present disclosure. For convenience, features different from those described above with reference to FIG. 5 may be described in more detail hereinafter.

Referring to FIG. 12, the first subplate 520 may include a first planar portion 520_PL and a first protruding portion 520_PR. The first subplate 520 may be the same or substantially the same as the first subplate 320 described above with reference to FIG. 5, except for the height of the first protruding portion 520_PR may be different. The height of the first protruding portion 520_PR may be a height at which the first terminal plate 580 contacts a first portion 580_P1. A cavity CA3 may be formed in the first protruding portion 520_PR.

A first cap assembly 550 may include a first cap plate 560, a first sealing member 570, and a first terminal plate 580. The first cap plate 560 and the first sealing member 570 may be the same or substantially the same as the first cap plate 360 and the first sealing member 370 described above with reference to FIG. 5. Thus, the first terminal plate 580 will be described in more detail hereinafter.

The first terminal plate 580 may be connected onto (e.g., coupled onto or attached onto) the first sealing member 570. The first terminal plate 580 may be the positive electrode terminal of the rechargeable battery. For example, a busbar may be welded to the first terminal plate 580 to be electrically connected to another rechargeable battery.

The first terminal plate 580 may include a first portion 580_P1 and a second portion 580_P2. The first portion 580_P1 may be in contact with the first protruding portion 520_PR. For example, the top surface of the first protruding portion 520_PR and the bottom surface of the first portion 580_P1 may be in contact with each other. The bottom surface 580_BS of the first terminal plate 580 may be flat or substantially flat. For example, the bottom surface of the first portion 580_P1 and the bottom surface of the second portion 580_P2 may be disposed at (e.g., in or on) the same plane as each other. The bottom surface 580_BS of the first terminal plate 580 may be defined as the bottom surface of the first portion 580_P1 and the bottom surface of the second portion 580_P2.

In some embodiments, with respect to the bottom surface 580_BS of the first terminal plate 580, the top surface of the first portion 580_P1 may be disposed lower than the top surface of the second portion 580_P2. The top surface of the first terminal plate 580 may include a recessed portion. The recessed portion may be defined as the top surface of first portion 580_P1 and a side surface of second portion 580_P2.

In some embodiments, with respect to the bottom surface 580_BS of the first terminal plate 580, the top surface of the first portion 580_P1 and the top surface of the second portion 580_P2 may be disposed at the same or substantially the same height as each other. In other words, the top surface of the first terminal plate 580 may be flat or substantially flat.

The first portion 580_P1 may be disposed at (e.g., in or on) a first through-hole TH3. The first portion 580_P1 may not be disposed in the first through-hole TH3. In a case where the first cap assembly 550 and the first subplate 520 are connected to (e.g., coupled to or attached to) each other, the first protruding portion 520_PR may be disposed in the first through-hole TH3 and may be in contact with the first portion 580_P1.

In FIG. 12, only the first cap assembly 550 and the first subplate 520 are illustrated for convenience, but the same or substantially the same may be applied to the second cap assembly and the second subplate.

According to embodiments of the present disclosure described above, the current collector may be removed from a comparative structure including three components (e.g., the terminal plate, the current collector, and the subplate), thereby reducing material costs.

The foregoing is illustrative of some embodiments of the present disclosure, and is not to be construed as limiting thereof. Although some embodiments have been described, those skilled in the art will readily appreciate that various modifications are possible in the embodiments without departing from the spirit and scope of the present disclosure. It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. Therefore, it is to be understood that the foregoing is illustrative of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A rechargeable battery comprising:
an electrode assembly;
a case configured to accommodate the electrode assembly;
a subplate comprising:
a first planar portion connected to the electrode assembly; and
a protruding portion protruding on the first planar portion;
a cap plate coupled to an open first side of the case; and
a terminal plate on the cap plate, and electrically connected to the subplate, the terminal plate comprising:
a recessed first portion comprising a bottom surface; and
a second portion comprising a second planar portion connected to the recessed first portion,
wherein the recessed first portion of the terminal plate is in contact with the protruding portion of the subplate.

2. The rechargeable battery as claimed in claim 1, wherein a thickness of the recessed first portion is greater than a thickness of the protruding portion.

3. The rechargeable battery as claimed in claim 1, wherein the first planar portion and the protruding portion of the subplate have a same thickness as each other.

4. The rechargeable battery as claimed in claim 1, wherein the recessed first portion that is in contact with the protruding portion protrudes from a bottom surface of the second portion toward the protruding portion.

5. The rechargeable battery as claimed in claim 1, further comprising a sealing member coupled onto the cap plate,
wherein the sealing member is located between the second portion of the terminal plate and the subplate.

6. The rechargeable battery as claimed in claim 5, wherein the sealing member has a through-hole, and the recessed first portion of the terminal plate is located in the through-hole.

7. The rechargeable battery as claimed in claim 6, wherein the recessed first portion of the terminal plate and the protruding portion of the subplate are in contact with each other in the through-hole of the sealing member.

8. The rechargeable battery as claimed in claim 1, wherein the protruding portion of the subplate has a cylindrical shape, and an interior of the protruding portion is hollow.

9. The rechargeable battery as claimed in claim 1, wherein an upper surface of the recessed first portion of the terminal plate is lower than an upper surface of the second portion of the terminal plate.

10. The rechargeable battery as claimed in claim 1, wherein the recessed first portion of the terminal plate exposes a portion of the protruding portion.

11. The rechargeable battery as claimed in claim 1, wherein the subplate comprises a forged product.

12. The rechargeable battery as claimed in claim 1, wherein the terminal plate further comprises a welding area on an upper surface of the recessed first portion.

13. The rechargeable battery as claimed in claim 1, wherein the case comprises:
a first long sidewall portion and a second long sidewall portion opposite to and spaced from each other; and
a first short sidewall portion and a second short sidewall portion opposite to and spaced from each other, and
wherein areas of the first short sidewall portion and the second short sidewall portion are smaller than areas of the first long sidewall portion and the second long sidewall portion, respectively.

14. A rechargeable battery comprising:
an electrode assembly;
a case configured to accommodate the electrode assembly;
a subplate comprising:
a first planar portion connected to the electrode assembly; and
a first protruding portion protruding on the first planar portion;
a cap plate coupled to an open first side of the case; and
a terminal plate on the cap plate, and electrically connected to the subplate, the terminal plate comprising:
a first portion comprising a second protruding portion protruding toward the first protruding portion; and
a second portion comprising a second planar portion in contact with the first portion,
wherein the first portion of the terminal plate is in contact with the first protruding portion of the subplate.

15. The rechargeable battery as claimed in claim 14, wherein the first planar portion and the first protruding portion of the subplate have a same thickness as each other.

16. The rechargeable battery as claimed in claim 14, wherein the first portion and the second portion comprise different materials from each other.

17. The rechargeable battery as claimed in claim 14, wherein the first portion comprises copper, and the second portion comprises aluminum.

18. The rechargeable battery as claimed in claim 14, wherein the first portion comprises a third planar portion in contact with the second portion.

19. The rechargeable battery as claimed in claim 14, wherein the second portion has a hole exposing the first portion.

20. A rechargeable battery comprising:
an electrode assembly;
a case configured to accommodate the electrode assembly, and having an open first side and an open second side opposite to each other;
a first subplate comprising:
a first planar portion connected to a first side of the electrode assembly; and
a first protruding portion protruding on the first planar portion;
a first cap plate coupled to the open first side of the case;
a first terminal plate on the first cap plate, and electrically connected to the first subplate, the first terminal plate comprising:
a recessed first portion comprising a bottom surface; and
a second portion comprising a third planar portion connected to the recessed first portion;
a second subplate comprising:
a second planar portion connected to a second side of the electrode assembly; and
a second protruding portion protruding on the second planar portion;
a second cap plate coupled to the open second side of the case; and
a second terminal plate on the second cap plate, and electrically connected to the second subplate, the second terminal plate comprising:
a third portion comprising a third protruding portion protruding toward the second protruding portion; and
a fourth portion comprising a fourth planar portion in contact with the third portion,
wherein the recessed first portion of the first terminal plate is in contact with the first protruding portion of the first subplate, and
wherein the third portion of the second terminal plate is in contact with the second protruding portion of the second subplate.
